(19) United States
(12) Patent Application Publication
(10) Pub. No.: US 2012/0197758 A1
(43) Pub. Date: Aug. 2, 2012

(54) COMPUTATION OF USER REPUTATION BASED ON TRANSACTION GRAPH

(75) Inventors: Qian Zhong, San Jose, CA (US); Ramakrishnan Natarajan, San Jose, CA (US); Parashuram Kulkarni, Santa Clara, CA (US); Abdelhalim Abbas, Mountain View, CA (US); Zhigang Hua, Campbell, CA (US)

(73) Assignee: eBay Inc., San Jose, CA (US)

(21) Appl. No.: 13/015,362

(22) Filed: Jan. 27, 2011

(51) Int. Cl. G06Q 30/00

(52) U.S. Cl. 705/26.35

(57) ABSTRACT

A method and a system generate a reputation value for a user in a network-based community. A processor-implemented transaction data collector module collects transaction data of users of a network-based community. A processor-implemented transaction graph generator module generates a transaction graph based on the collected transaction data. The transaction graph has a transaction relationship between two users, and a weight corresponding to the transaction relationship. The weight is representative of a mutually reinforcing relationship between two users. A processor-implemented reputation generator module generates a reputation value for a user from the transaction graph.

### TECHNICAL FIELD

This application relates to a method and system for identifying users using reputational data.

### BACKGROUND

As online applications mature, users and merchants increasingly communicate and participate in a variety of transactions and commerce with each other. Buyers and sellers (e.g., individuals and merchants) transact with each other based on good faith and whatever knowledge they may have about each other as transacting parties and/or members of the transacting community. However, as in any community, the trustworthiness and reliability of buyers and sellers will vary.

The ability to ascertain these and other reputational qualities of a party to a transaction is one hurdle to overcome for improving transaction experiences.

### BRIEF DESCRIPTION OF TEE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2A is a block diagram illustrating an example embodiment of a publication application;

FIG. 2B is a block diagram illustrating an example embodiment of a reputation application;

FIG. 3A is a block diagram illustrating an example of a transaction graph;

FIG. 3B is a block diagram illustrating an example of a transaction graph for computing a hub score of a buyer;

FIG. 3C is a block diagram illustrating an example of a transaction graph for computing an authority score of a seller;

FIG. 4 is a block diagram illustrating a metric module for generating a hub value of a buyer and an authority value of a seller;

FIG. 5 is a flow chart of an example method for generating a reputation value of a user;

FIG. 6 is a flow chart of an example method for generating a probability of a completed transaction between a seller and a buyer;

FIG. 7 is a flow chart of an example method for generating hub values and authority values;

FIG. 8 is a flow chart of another example method for generating hub values and authority values; and

FIG. 9 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In various embodiments, a system and method to generate a reputation value of a user of a network-based community is disclosed. Transaction data among users of a network-based community is collected in a database. User behavior can be modeled by constructing a user transaction graph, where nodes in the user transaction graph represent the users, and the direction of the links or edges represents the direction of cash flow (money transfer from one user to another). A weight corresponding to a transaction relationship between two users is generated based on the number of transactions and/or the amount of total transactions between the two users over a pre-defined duration. A hub value and an authority value for each user are computed. The hub values are mutually dependent on the authority values. In particular, the hub value of a user is based on the corresponding authority value of other users whom the user is buying from. The authority value of a user is based on the hub value of other users whom the user is setting to. In this framework, authority nodes may consist of authority sellers (sellers who sell a lot to buyers with hub values). Hub nodes may consist of hub buyers (buyers who buy from a lot of sellers with high authority values).

Such authority value may provide amore accurate way to measure reputations among users in the network-based community instead of just using the absolute numbers of transactions or dollar amount of transactions. For example, a current ranking scheme ranks a seller's reputation based on the seller's number of transactions and the feedback rating from buyers who transacted with the seller. Therefore, it would require some time to promote the reputation of a new seller since the new seller would have to accumulate a relatively high number of transactions and positive feedbacks.

As such, the authority and hub values provide a more effective scheme to boost new legitimate sellers and downgrade spam sellers. Moreover, the authority and hub values improve the accuracy of predicting an item's sale probability between two users.

The traditional user reputation ranking system for a network-based community is typically derived from the number of transactions and the dollar amount of transactions. Unlike the traditional ranking system, the current system is derived from a dynamic user transaction graph, which captures the dynamics of the interactions between sellers and buyers.

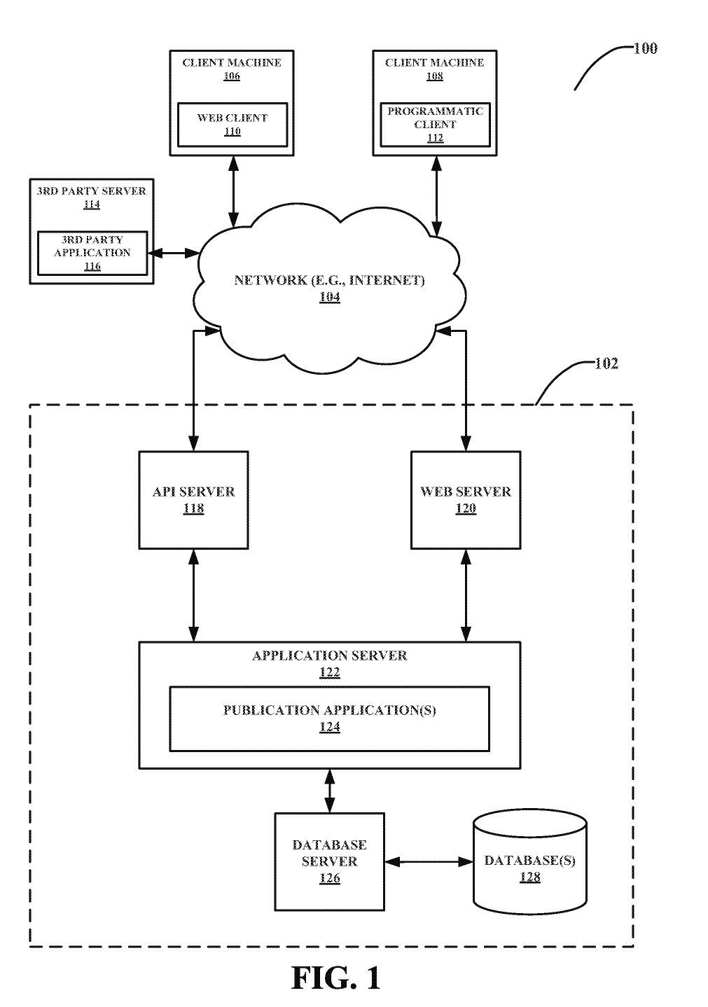

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet) to one or more clients. The one or more clients may include users that utilize the network system 100 and more specifically, the network-based publisher 102, to exchange data over the network 114. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party application 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

Turning specifically to the network-based publisher 102, an application program interface (API) server 118 and a web server 120 are coupled to, and provide programmatic and web interfaces respectively to, one or more application servers 122. The application servers 122 host one or more publication application (s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., client application 112 or third party application 116) running on another client machine (e.g., client machine 108 or third party server 114).

The publication application(s) 124 may provide a number of publisher functions and services (e.g., listing, payment, etc.) to users that access the network-based publisher 102. For example, the publication application(s) 124 may provide a number of services and functions to users for listing goods and/or services for sale, facilitating transactions, and reviewing and providing feedback about transactions and associated users. Additionally, the publication application(s) 124 may track and store data and metadata relating to financial transactions among users of the network-based publisher 102. The publication application(s) 124 may also collect feedback from buyers based on the corresponding financial transactions with sellers. In one example embodiment, from the collected data, the publication application(s) 124 may determine a reputation in the form of a score or value, for users of the network-based community. The reputation value may be computed based on the collected financial transaction data between the users.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

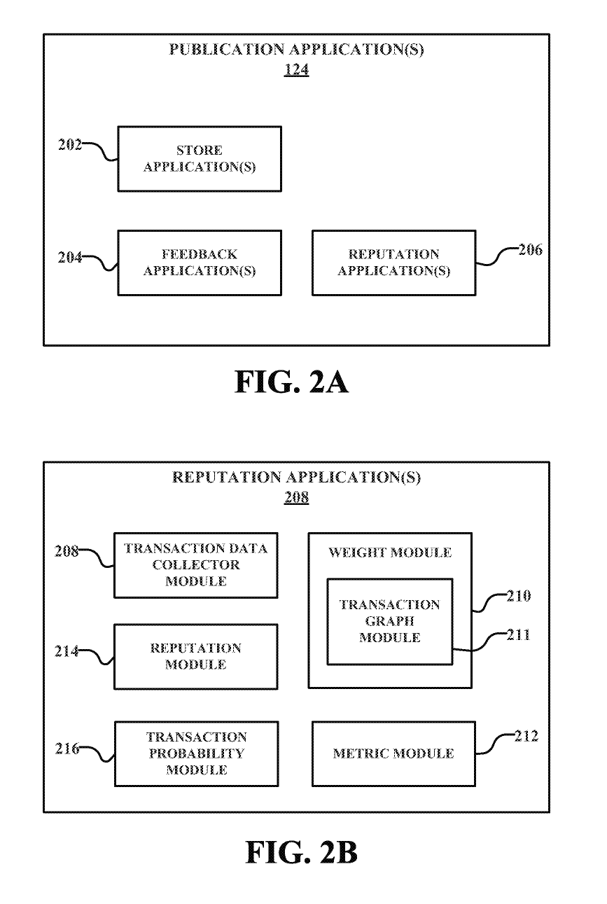

FIG. 2A is a block diagram illustrating an example embodiment of a publication application 124, which is provided as part of the network-based publisher 102. The network-based publisher 102 may provide a multitude of feedback, reputation, and listing and price-setting mechanisms whereby a user may be a seller or buyer who lists or buys goods and/or services (e.g., for sale) published on the network-based publisher 102.

The publication application(s) 124 are shown to include, among other things, one or more application(s) which support the network-based publisher 102, and more specifically, the listing of goods and/or services for sale, the receipt of feedback in response to a transaction involving a listing, and the generation of reputation values for users based on transaction data between users.

Store application(s) 202 permit sellers to list individual goods and/or services (hereinafter generically referred to as “items”) for sale via the network-based publisher or group their listings within a “virtual” store, which may be branded and otherwise personalized by and for the sellers. Individual and grouped listings may include details such as a title of an item offered for sale, a description of the item, a price of the item, one or more pictures of the item, a geographic location of the seller or the item, payment and shipping options, and a return policy. The virtual store also may offer promotions, incentives and features that are specific and personalized to a relevant seller.

Feedback application(s) 204 may allow parties that transact using the network-based publisher 102 to establish, build, and maintain buyer or seller reputations, which may be made available and published to potential trading partners (e.g., users of the network-based publisher 102). Consider, for example, where the network-based publisher 102 supports person-to-person trading, users may have no history or other reference information whereby the trustworthiness and/or credibility of potential trading partners may be assessed. The feedback application(s) 204 may allow a first user, for example through feedback provided by other users, to establish a buyer/seller reputation within the network-based publisher 112 over time and transactions. Thus, other potential transaction partners (users) may then reference the buyer/seller reputation value of the user for the purpose of assessing credibility, trustworthiness, etc.

Feedback may be received in the form of answers to a series of questions concerning topics such as satisfaction with a transaction, speed in concluding a transaction, and promptness of payment or shipping. Feedback additionally may be received in the form of comments input by a counterparty to the transaction. Both types of feedback may be viewed by the user to whom they are directed and other parties who access a profile of the user, and may be segregated on a per transaction basis. Conventionally, feedback is limited to the answers and comments provided by counter-party, thereby providing a user with only a limited perspective of how the user has performed or how the user is perceived by others in the network-based community.

Reputation application(s) 206 may operate on the transaction data between users and optionally on the received feedback to determine a user's reputation. It can be appreciated by one skilled in the art that users may have a multitude of various types of reputation values in the network-based publisher 102. For example, a user may have a reputation value for being a buyer and one as a seller. The user's reputation value may be based on one or more user attributes determined from transaction data, feedback or metadata. The user attributes may include, but are not limited to, weights or values assigned to a user based on the user's frequency of interaction with the network-based publisher 102, the number of items a user has sold, the promptness of the user in concluding a transaction or shipping an item, feedback ratings, the length of time a user has been using the network-based publisher 102, and a category of transaction including a user's expertise (e.g., power seller) in a category.

Reputation application(s) 206 may provide user reputation data to third party applications through an exposed application programming interface (API). In this respect, third party applications may query the network-based publisher 102 for a trustworthiness determination for a user of the third party system, who may or may not also be a user of the network-based community 100. If the user is part of the network-based community 100, reputation application(s) 206 may retrieve and provide the user's reputation value to the third party system, or may make a determination of trustworthiness and provide the determination to the third party system.

FIG. 2B is a block diagram illustrating an example embodiment of modules in the reputation application 206. The modules may include a transaction data collector module 208, a weight module 210, a metric module 212, a reputation module 214, and a transaction probability module 216.

In one embodiment, the transaction data collector module 208 is configured to collect transaction data of users of a network-based community. As described above, the transaction data can include, but is not limited to, the number of transactions between users, the monetary amount of each transaction, the total amount of all transactions from a user, the total amount of transaction for a user, the number of items bought or sold by the user, feedback ratings, the length of time since the user has been using the network-based publisher 102, the length of a time since the user has purchased or sold an item from or to another user of the network-based community, a category of transaction including a user's expertise (e.g., power seller) in a category. Transaction data collected by the transaction data collector module 208 may be stored in the database 128 in FIG. 1.

The weight module 210 retrieves transaction data stored in the database 128. The weight module 210 computes a weight corresponding to a transaction relationship between two users (e.g. a buyer and a seller). For example, the weight may be based on the number of transactions between the buyer and the seller (e.g. the buyer bought several times from the same seller), the monetary amount of the total number of transactions (e.g. the buyer bought x dollars worth of goods from the same seller), or a combination of both number of transactions and total amount of transactions. Furthermore, the weight may also be based on other data such as the feedback of the buyer and seller (e.g. a feedback rating of the buyer and the seller).

In another embodiment, weight module 21) includes a transaction graph module 211. The transaction graph module 211 may generate a graph based on the recorded transaction data between users. The transaction graph includes nodes and links between the nodes. Each node identifies a user (e.g. a buyer or a seller and a direction of a link identifies a cash flow direction between two nodes (e.g. from a buyer to a seller). Each node can act as buyer and/or seller with respect to other nodes.

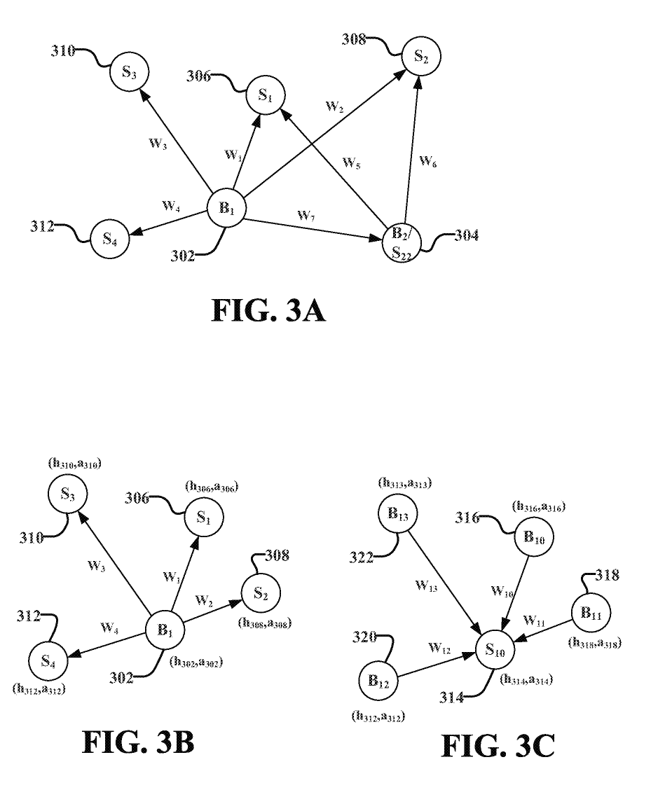

FIG. 3A illustrates an example of a transaction graph based on transaction data between nodes 302, 304, 306, 308, 310, and 312. Each node represents a user acting either as a buyer (B) and/or a seller (S). For example, FIG. 3A illustrates a node 302 (B₁) as a buyer with respect to node 306 (S₁) which is acting as a seller. The direction of the link or edge between node 302 (B₁) and node 306 (S₁) represents the flow of money (e.g. buyer (B₁) transferred money to seller (S₁) for a purchased item). It should be noted that a node can act both as a buyer and a seller with respect to other nodes. For example, node 304 is a buyer (B₂) with respect to a financial transaction with node 308 (S₂) (e.g. buyer (B₂) transferred money to seller (S₂) for a purchased item). Node 304 may also be a seller (S₂₂) with respect to a financial transaction with node 302 (B₁) (e.g. buyer (B₁) transferred money to seller (S₂₂) for a purchased item).

Each transaction is represented by an arrow having a direction of the cash flow, and a corresponding weight wᵢ. For example, the weight (w₁) is based on transactions between node 302 (B₁) and node 306 (S₁). In one embodiment, w₁ is a function of the total number of transactions between node 302 (B₁) and node 306 (S₁) and/or the total amount of transactions between node 302 (B₁) and node 306 (S₁).

Back to FIG. 2B, the metric module 212 computes a first metric and a second metric for a user (node) where the first metric is mutually dependent on the second metric. In other words, it is assumed that good buyers and sellers will reinforce each other. In one embodiment, the first metric includes a hub value and the second metric includes an authority value. Each node has a hub and/or authority value. The hub value of a node is based on the authority values of other nodes having a transaction relationship with the node and their corresponding weights. The authority value of a node is based on the hub values of other nodes having a transaction relation with the node and their corresponding weights.

In one embodiment, an algorithm such as Hyperlink-Inducted Topic Search (HITS) algorithm may be applied to the transaction graph in FIG. 3A to compute hub and authority values. As such, instead of computing the authority and hub value from a graph adjacency matrix A, a directed weighed graph can be constructed whose edge weight represents the number of transactions or the amount of total transactions. Thus, the adjacency matrix may be expressed as follows: Aᵢⱼ=edge_weight (i,j).

FIG. 3B illustrates an example of a transaction graph for the computation of a hub value h₃₀₂ of node 302 (B₁). Based on data transaction records, node 302 (B₁) bought from several seller nodes 306, 308, 310, and 312 (S₁, S₂, S₃, and S₄). Each transaction relationship is associated with a corresponding weight (w₁, w₃, w₃, and w₄). As such, the hub value h₃₀₂ of node 302 (B₁) is based on the corresponding weights (w₁, w₂, w₃, and w₄) and authority values (a₃₀₆, a₃₀₈, a₃₁₀, and a₃₁₂) of nodes 306, 308, 310, and 312.

The hub value of a node may be represented as follows:

Hub value of a buyer Bᵢ=Σ authority value of seller Sᵢ×wᵢ

FIG. 3C illustrates an example of a transaction graph for the computation of an authority value a₃₁₄ of node 314 (S₁₀). Based on data transaction records, node 314 (S₁₀) sold to several buyer nodes 316, 318, 320, and 322 (B₁₀, B₁₁, B₁₂, and B₁₃). Each transaction relationship is associated with a corresponding weight (w₁₀, w₁₁, w₁₂, and w₁₃). As such, the authority value a₃₁₄ of node 314 (S₁₀) is based on the corresponding weights (w₁₀, w₁₁, w₁₂, and w₁₃) and hub values (h₃₁₆, h₃₁₈, h₃₂₀, and h₃₂₂) of nodes 316, 318, 320, and 322.

The authority value of a node may be represented as follows:

Authority value of a seller Sᵢ=Σ hub value of a buyer Bᵢ×wᵢ

In other words, the hub nodes include smart buyers who buy from a lot of authority sellers. Conversely, the authority nodes include authority sellers who sell a lot to smart buyers.

Back to FIG. 2B, the reputation module 214 computes a reputation value for a user based on at least one of the corresponding weight of transaction relationships with other users, the hub value, and the authority value. In one embodiment, the reputation value for a node as a seller is a function of its authority value. The reputation value for a node as a buyer is a function of its hub value. The reputation value indicates a trustworthiness of the user. As such, a seller with a high authority value will likely have a high reputation. A buyer with a high hub value will likely have a high reputation.

The transaction probability module 216 computes a probability of a completed transaction between two users based on the previously computed reputation values of two nodes. For example, the probability of a successfully completed financial transaction between a seller with a high reputation value and a buyer with a high reputation value is relatively higher than the probability of a successfully completed financial transaction between a seller with a low reputation value and a buyer with a low reputation value, between a seller with a high reputation value and a buyer with a low hub value, or between a seller with a low reputation value and a buyer with a high reputation value.

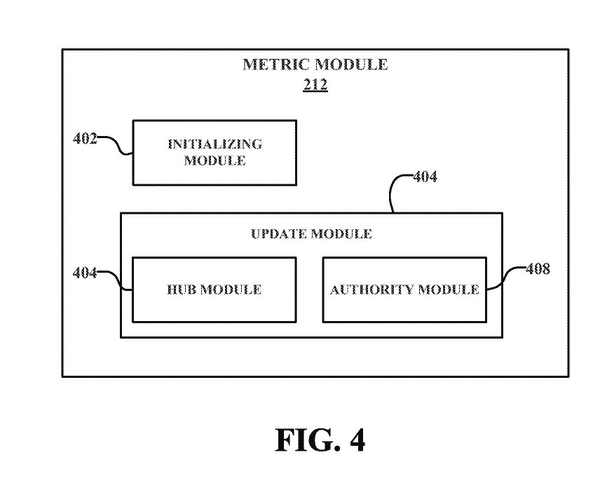

FIG. 4 is block diagram of an example of the metric module 212. An initializing module 402 initializes the hub values and the authority values of all users. In one embodiment, the hub value of a user is based on the sum of the product of the authority value of other users having a transaction relationship with the user and their corresponding weights. The authority value of the user is based on the sum of the product of the hub value of other users having a transaction relationship with the user and their corresponding weights.

An updater module 404 updates the hub value and the authority value for all users based on the initialized hub value and the initialized authority value of all users. The updater module 404 includes a hub value updater 406 and an authority value updater 408.

In one embodiment, the hub value updater 406 updates the hub value of all users based on the initialized authority value of all users. The authority value updater 408 then updates the authority value of all users based on the updated hub value of all users.

In another embodiment, the authority value updater 408 updates the authority value of all users based on the initialized hub value of all users. The hub value updater 406 updates the hub value of all users based on the updated authority value of all users.

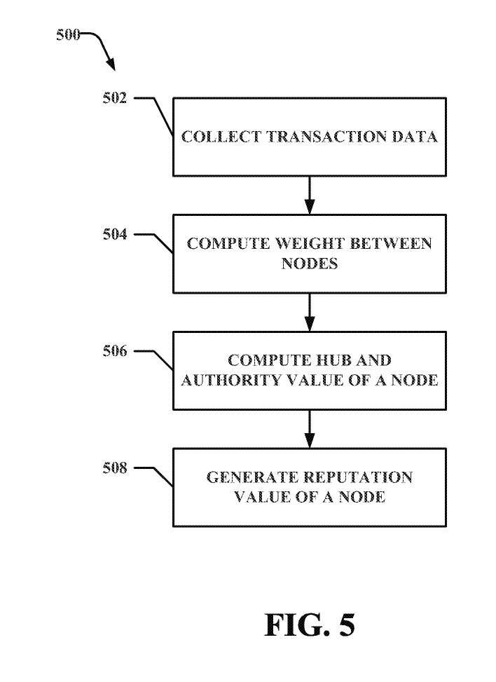

FIG. 5 is a flow chart of an example method for generating a reputation value of a user/node. At operation 502, transaction data of users/nodes of a network-based community are collected and stored in a database. At operation 504, the weight corresponding to a transaction relationship between two users/nodes is computed. The weight is based on transactions between the two users/nodes. At operation 506, a hub value and an authority value for a user/node is computed. The hub value is mutually dependent on the authority value. At operation 508, a reputation value for the user/node is generated based on at least one of the corresponding weight of transaction relationships with other users/nodes, the hub value, and/or the authority value of the user/node.

If sellers were ranked according to the number of transactions (or the dollar amount) they made, it would take quite a significant amount of time for a new seller to build up his credit. Now the hub and authority scheme implicitly suggests that if a new user could start his business with a few high value hubs (good buyers), t is faster for him to build his credit (authority value). The assumption here is that good buyers know where to get good deals. So if a new seller is able to attract the good buyers' attention, the system is able to give proper credit.

On the other hand, this could also be used as a scheme to downgrade some users. For example, if a reputable user (a hub or an authority user) leaves a negative feedback to another user, the effects of the negative feedback are intensified given the good reputation of the reputable user.

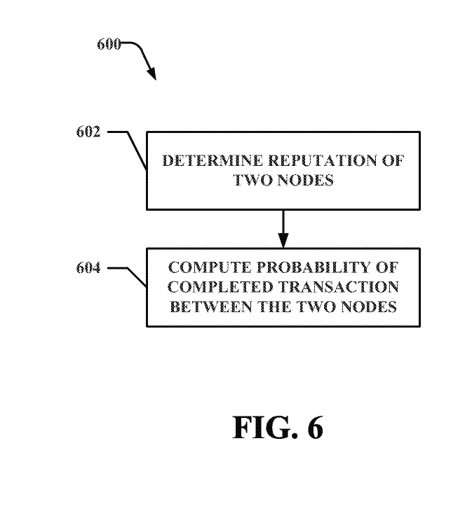

FIG. 6 is a flow chart of an example method for generating a probability of a completed transaction between two users/nodes. At operation 602, the reputation of two users/nodes is computed according to the previously described operation. At 608, the probability of a transaction completed between the two users/nodes is computed based on the reputation of the two users. As previously described, the probability of a successfully completed financial transaction between a seller with a high reputation value and a buyer with a high reputation value is relatively higher than the probability of a successfully completed financial transaction between a seller with a low reputation value and a buyer with a low reputation value, between a seller with a high reputation value and a buyer with a low hub value, or between a seller with a low reputation value and a buyer with a high reputation value.

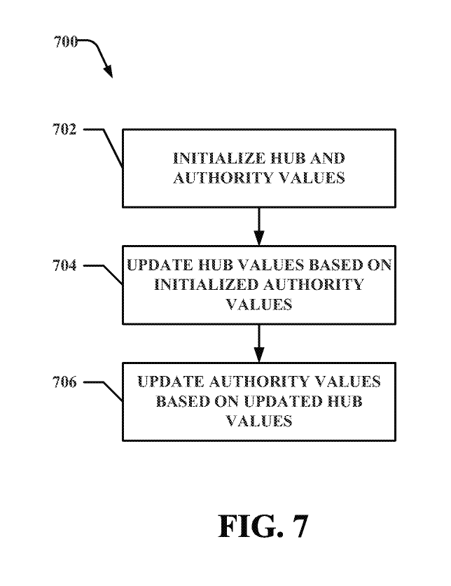

FIG. 7 is a flow chart of an example method for generating hub values and authority values. At 702, the hub values and the authority values of all users/nodes are initialized. As previously discussed, the hub value of a user/node is based on the sum of the product of the authority value of other users/nodes having a transaction relationship with the user/node and their corresponding weights. The authority value of the user/node is based on the sum of the product of the hub value of other users/nodes having a transaction relationship with the user/node and their corresponding weights.

At 704, the hub values of all users/nodes are updated based on the initialized authority values of all users/nodes. At 706, the authority values of all users/nodes are updated based on the updated hub values of all users/nodes.

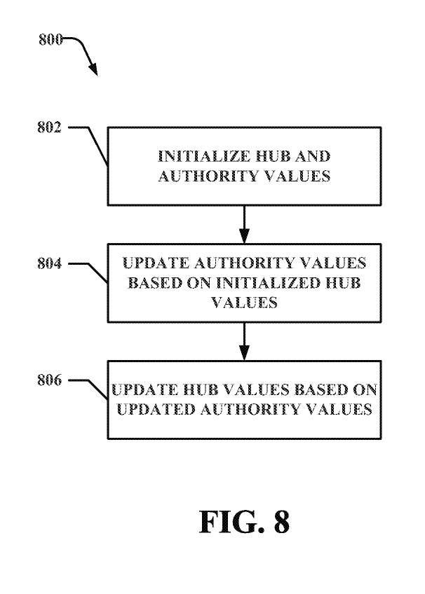

FIG. 8 is a flow chart of another example method for generating hub values and authority values. At 802, the hub values and the authority values of all users/nodes are initialized. As previously discussed, the hub value of a user/user is based on the sum of the product of the authority value of other users/nodes having a transaction relationship with the user/node and their corresponding weights. The authority value of the user/node is based on the sum of the product of the hub value of other users/nodes having a transaction relationship with the user/user and their corresponding weights.

At 804, the authority values of all users/nodes are updated based on the initialized hub values of all users/nodes. At 806, the hub values of all users/nodes are updated based on the updated authority values of all users/nodes.

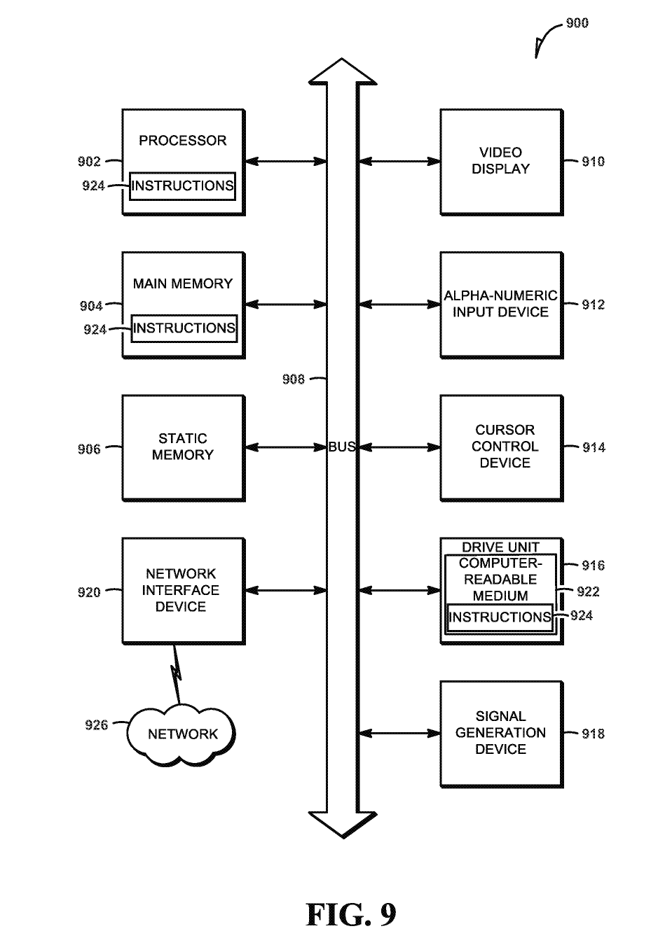

FIG. 9 shows a diagrammatic representation of machine in the example form of a computer system 900 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920 utilizing any one of a number of well-known transfer protocols (e.g., HTTP).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system, comprising:
a processor-implemented transaction data collector module configured to collect transaction data of users of a network-based community;
a processor-implemented weight module coupled to the processor-implemented transaction data collector module, the processor-implemented weight module configured to compute a weight corresponding to a transaction relationship between two users, the weight based on transactions between the two users;
a processor-implemented metric module coupled to the processor-implemented weight module, the processor-implemented metric module configured to compute a first metric and a second metric for a user, the first metric mutually dependent on the second metric; and
a processor-implemented reputation module coupled to the processor-implemented weight module and the processor-implemented metric module, the processor-implemented reputation module configured to generate a reputation value for the user based on at least one of the corresponding weight of transaction relationships with other users, the first metric, and the second metric.

2. The system of claim 1 wherein the transaction relationship identifies the user as a seller or a buyer.

3. The system of claim 1 wherein the reputation value indicates a trustworthiness of the user, the first metric includes a hub value, and the second metric includes an authority value.

4. The system of claim 1 wherein the weight module further comprises:
a processor-implemented transaction graph module configured to generate a transaction graph based on the transaction data of users, wherein the transaction graph comprises at least two nodes, links between the nodes, each node identifying a user, and a direction of a link identifying a cash flow direction between two nodes.

5. The system of claim 1 wherein the weight is based on at least one of a number of transactions between two users, a total amount of all transactions between two users, and a feedback rating of at least one of the two users.

6. The system of claim 1 wherein the processor-implemented metric module further comprises:
a processor-implemented initializing module configured to initialize the first metric and the second metric of all users, wherein the first metric of a user is based on the sum of the product of the second metric value of other users having a transaction relationship with the user and their corresponding weights, wherein the second metric of the user is based on the sum of the product of the first metric of other users having a transaction relationship with the user and their corresponding weights; and
a processor-implemented updater module configured to update the first metric and the second metric for all users based on the initialized first metric and the initialized second metric of all users.

7. The system of claim 6 wherein the processor-implemented updater module is further configured to update the first metric of all users based on the initialized second metric of all users, and to update the second metric of all users based on the updated first metric of all users.

8. The system of claim 6 wherein the processor-implemented updater module is further configured to update the second metric of all users based on the initialized first metric of all users, and to update the first metric of all users based on the updated first metric of all users.

9. The system of claim 6 wherein the processor-implemented reputation module is further configured to compute the reputation value of the user based on the updated first metric and the updated second metric of the user.

10. The system of claim 9 further comprising:
a processor-implemented transaction probability module configured to compute a probability of a completed transaction between two users based on at least the reputation value of the two users.

11. A computer-implemented method, comprising:
collecting transaction data of users of a network-based community;
computing a weight corresponding to a transaction relationship between two users, the weight based on transactions between the two users;
computing a first metric and a second metric for a user, the first metric mutually dependent on the second metric; and
generating, by a processor, a reputation value for the user based on at least one of the corresponding weight of transaction relationships with other users, the first metric, and the second metric.

12. The computer-implemented method of claim 11 wherein the transaction relationship identifies the user as a seller or a buyer.

13. The computer-implemented method of claim 11 wherein the reputation value indicates a trustworthiness of the user, the first metric includes a hub value, and the second metric includes an authority value.

14. The computer-implemented method of claim 11 further comprising:
generating a transaction graph based on the transaction data of users, wherein the transaction graph comprises at least two nodes, links between the nodes, each node identifying a user, and a direction of a link identifying a cash flow direction between two nodes.

15. The computer-implemented method of claim 11 wherein the weight is based on at least one of a number of transactions between two users, a total amount of all transactions between two users, and a feedback rating of at least one of the two users.

16. The computer-implemented method of claim 11 further comprising:
initializing the first metric and the second metric of all users, wherein the first metric of a user is based on the sum of the product of the second metric value of other users having a transaction relationship with the user and their corresponding weights, wherein the second metric of the user is based on the sum of the product of the first metric of other users having a transaction relationship with the user and their corresponding weights; and
updating the first metric and the second metric for all users based on the initialized first metric and the initialized second metric of all users.

17. The computer-implemented method of claim 16 further comprising:
updating the first metric of all users based on the initialized second metric of all users; and
updating the second metric of all users based on the updated first metric of all users.

18. The computer-implemented method of claim 16 further comprising:
updating the second metric of all users based on the initialized first metric of all users; and
updating the first metric of all users based on the updated first metric of all users.

19. The computer-implemented method of claim 16 further comprising:
computing the reputation value of the user based on the updated first metric and the updated second metric of the user.

20. The computer-implemented method of claim 19 further comprising:
computing a probability of a completed transaction between two users based on at least the reputation value of the two users.

21. A non-transitory computer-readable storage medium storing a set of instructions that, when executed by a processor, causes the processor to perform operations, comprising:
collecting transaction data of users of a network-based community;
computing a weight corresponding to a transaction relationship between two users, the weight based on transactions between the two users;
computing a first metric and a second metric for a user, the first metric mutually dependent on the second metric; and
generating, by a processor, a reputation value for the user based on at least one of the corresponding weight of transaction relationships with other users, the first metric, and the second metric.

22. The non-transitory computer-readable storage medium of claim 21 wherein the transaction relationship identifies the user as a seller or a buyer.

23. The non-transitory computer-readable storage medium of claim 21 wherein the reputation value indicates a trustworthiness of the user, the first metric includes a hub value, and the second metric includes an authority value.

24. The non-transitory computer-readable storage medium of claim 21 further comprising:
generating a transaction graph based on the transaction data of users, wherein the transaction graph comprises at least two nodes, links between the nodes, each node identifying a user, and a direction of a link identifying a cash flow direction between two nodes.

25. The non-transitory computer-readable storage medium of claim 21 wherein the weight is based on at least one of a number of transactions between two users, a total amount of all transactions between two users, and a feedback rating of at least one of the two users.

26. The non-transitory computer-readable storage medium of claim 21 further comprising:
initializing the first metric and the second metric of all users, wherein the first metric of a user is based on the sum of the product of the second metric value of other users having a transaction relationship with the user and their corresponding weights, wherein the second metric of the user is based on the sum of the product of the first metric of other users having a transaction relationship with the user and their corresponding weights; and
updating the first metric and the second metric for all users based on the initialized first metric and the initialized second metric of all users.

27. The non-transitory computer-readable storage medium of claim 26 further comprising:
updating the first metric of all users based on the initialized second metric of all users; and
updating the second metric of all users based on the updated first metric of all users.

28. The non-transitory computer-readable storage medium of claim 26 further comprising:
updating the second metric of all users based on the initialized first metric of all users; and
updating the first metric of all users based on the updated first metric of all users.

29. The non-transitory computer-readable storage medium of claim 26 further comprising:
computing the reputation value of the user based on the updated first metric and the updated second metric of the user.

30. The non-transitory computer-readable storage medium of claim 29 further comprising:
computing a probability of a completed transaction between two users based on at east the reputation value of the two users.
